(19) United States
(12) Patent Application Publication
(10) Pub. No.: US 2009/0195705 A1
(43) Pub. Date: Aug. 6, 2009

(54) INFORMATION PROCESSING DEVICE AND CONTROL METHOD THEREOF

(75) Inventors: Kenji Koyano, Hanno-shi (JP); Hidehito Izawa, Hanno-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/359,128

(22) Filed: Jan. 23, 2009

(30) Foreign Application Priority Data
Jan. 31, 2008 (JP) 2008-021898

(51) Int. Cl. H04N 5/44

(52) U.S. Cl. 348/734; 348/E05.096

(57) ABSTRACT

According to one embodiment, an information processing device includes an output module which outputs video and audio information, and a processing circuit which processes the video and audio information to be output from the output module. The processing circuit includes a key-operation module which is operated to input a command, a remote controller light receiving module which detects a command input from a remote controller, and a control module which controls the output module based on a command obtained from each of the key-operation module and the remote controller light receiving module. The control module is configured to confirm which one of the key-operation module and the remote controller is used to input the command and change an output state of the output module for an operator who is at a position apart from the output module when the command is input from the remote controller.

### CROSS-REFERENCE TO RELATED APPLICATIONS

This application is based upon and claims the benefit of priority from Japanese Patent Application No. 2008-021898, filed Jan. 31, 2008, the entire contents of which are incorporated herein by reference.

### BACKGROUND

1. Field

The present invention relates to an information processing device that processes video or audio information in accordance with a command input from a key-operation module or an external remote controller.

2. Description of the Related Art

In recent years, a portable audio player including a video display is spreading. This portable audio player is an information processing device that can play back movie or music contents or receive a television broadcast.

This audio player is controlled by various kinds of commands input by utilizing a remote controller or a key-operation module in a main body. As a specific example, when, e.g., a menu command is input, a menu window is displayed on a video display. When a sound volume increase command is input, a value of a sound volume is displayed on the video display. When a subtitle command is input, a subtitle is displayed on the video display. Operation confirming sound may be output for each command input.

Meanwhile, since the remote controller is wirelessly connected with the audio player, the audio player can be controlled to perform an operation corresponding to a command input by the remote controller at a position apart from the audio player. At this time, a user of the audio player, i.e., an operator may feel that display characters and operation confirming sound are small in some cases. There has been conventionally known a technology of measuring a distance from an information display device (a video display) to a remote controller to optimize a size of display characters (see, e.g., JP-A 2004-287168 (KOKAI)).

However, since the information display device disclosed in JP-A 2004-287168 must measure a distance in order to grasp a position of the operator, this results in an increase in cost. Further, JP-A 2004-287168 (KOKAI) does not propose grasping a position of the operator irrespective of measurement of a distance.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an appearance of a portable audio player according to an embodiment of the present invention;

FIG. 2 is an exemplary diagram schematically showing the circuit configuration of the portable audio player shown in FIG. 1;

FIG. 3 is an exemplary diagram showing an output state obtained when a menu command is input by an operation of a key-operation module on a main body of the portable audio player shown in FIG. 1;

FIG. 4 is an exemplary diagram showing an output state obtained when a menu command is input by an operation of a key-operation module on a remote controller shown in FIG. 1;

FIG. 5 is an exemplary flowchart showing a control operation of a CPU shown in FIG. 2;

FIG. 6 is an exemplary flowchart showing command processing shown in FIG. 5 in detail;

FIG. 7 is a diagram showing an example where a large external display is connected to the portable audio player with the use of an external input and output interface shown in FIG. 2;

FIG. 8 is an exemplary flowchart showing command processing applied to the case where display characters and operation confirming sound are output by always using the external display connected as shown in FIG. 7; and

FIG. 9 is an exemplary flowchart showing command processing applied to the case where a set of display characters and operation confirming sound are output by selectively using the external display connected as shown in FIG. 7.

### DETAILED DESCRIPTION

Various embodiments according to the invention will be described hereinafter with reference to the accompanying drawings.

According to one embodiment of the invention, there is provided an information processing device comprising: an output module which outputs video and audio information; and a processing circuit which processes the video and audio information to be output from the output module; wherein the processing circuit includes a key-operation module which is operated to input a command, a detecting module which detects a command input from a remote controller, and a control module which controls the output module based on a command obtained from each of the key-operation module and the detecting module, and the control module is configured to confirm which one of the key-operation module and the remote controller is used to input the command and change an output state of the output module for an operator who is at a position apart from the output module when the command is input from the remote controller.

According to one embodiment of the invention, there is provided a control method for an information processing device comprising an output module which outputs video and audio information and a processing circuit which processes the video and audio information to be output from the output module, the processing circuit including a key-operation module which is operated to input a command, a detecting module which detects a command input from a remote controller, and a control module which controls the output module based on an output signal from each of the key-operation module and the detecting module, the method comprising: confirming which one of the key-operation module and the remote controller is used to input a command; and changing an output state of the output module for an operator who is at a position apart from the output module when the command is input from the remote controller.

According to the information processing device and the control method thereof, which one of the key-operation module and the remote controller has been used to input a command is confirmed, and an output state of the output module is changed for an operator who is at a position apart from the output module when the command has been input from the remote controller. Here, the fact that the operator has used the remote controller to input the command is a criterion for a determination that the operator is at the position apart from the output module. When the output state such as a display size or a sound volume is changed for the operator who is at the position apart from the output module based on this determination, easiness of viewing and listening by the operator can be improved. Even if the operator is at a position near the output module, since the key-operation module in the device main body can be used to input a command, there occurs no inconvenience due to a change in the output state.

A portable audio player according to an embodiment of the present invention will now be explained hereinafter.

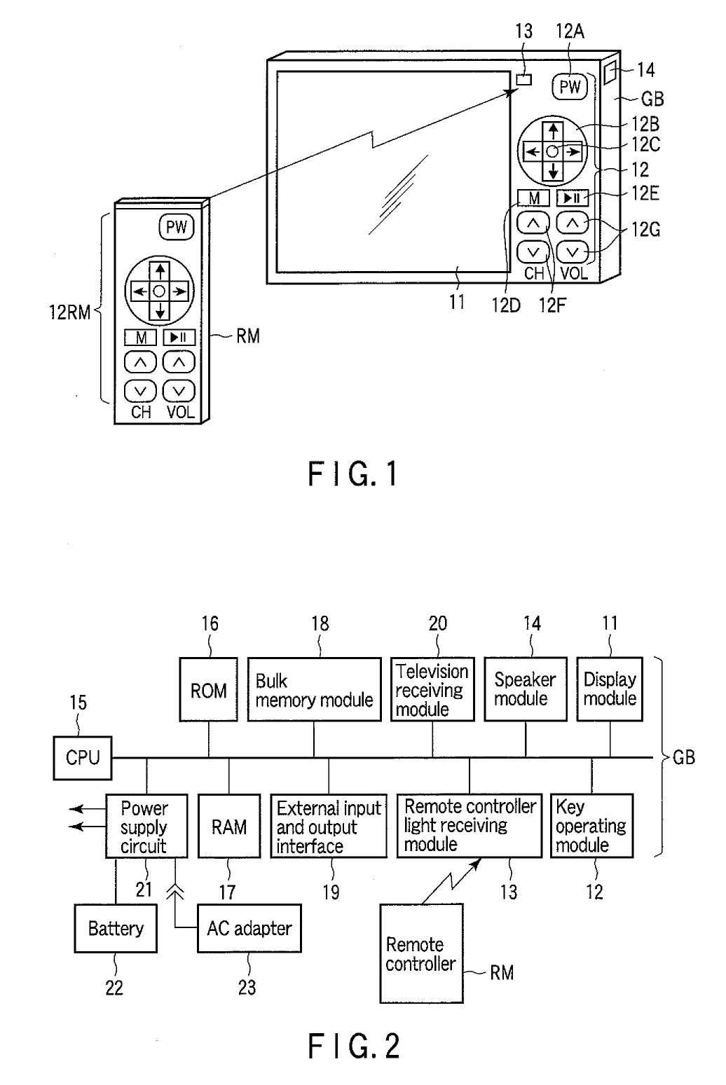

FIG. 1 shows an appearance of this portable audio player GB. FIG. 2 schematically shows the circuit configuration of the portable audio player GB. As shown in FIG. 1, the portable audio player GB includes a display module 11 provided as a video display that displays video information such as a moving image or a still image of a picture, characters or the like, a key-operation module 12 which is operated to input various commands by an operator as a user, a remote controller light receiving module 13 that receives an infrared signal from an external remote controller RM, and a speaker module 14 that outputs audio information such as music, operation confirming sound or the like. Here, the display module 11 and the speaker module 14 serve as an output module for the video information and audio information. For example, the key-operation module 12 includes a power supply key 12A for switching between a normal operation state and a standby operation state, cursor movement keys 12B for moving a cursor in upward, downward, left, and right directions, a decision key 12C for selecting an item, a menu key 12D for requesting a display of a menu window, a playback key 12E for switching between start and stop of content playback, channel up-down keys 12F for changing a receiving channel, and sound volume up-down keys 12G for changing a sound volume. The remote controller 12 includes a key-operation module 12RM including the same keys as those in the key-operation module 12 in the portable audio player GB main body to input various commands, and is used to remotely operate the wirelessly connected portable audio player GB by utilizing, e.g., infrared ray radiation. Specifically, a key operation in the key-operation module 12RM carried out by an operator is transmitted to the portable audio player GB in the form of an infrared signal. The remote controller light receiving module 13 is used as a detecting module that detects from this infrared signal a command input by the key operation in the key-operation module 12RM. It is to be noted that the power supply key 12A, the menu key 12D, the playback key 12E, the up-down keys 12F, and the up-down keys 12G are solely operated to input a command, but the cursor movement keys 12B and the decision key 12C are operated in combination to input a command.

The portable audio player GB further includes a CPU 15 that controls entire operations, an ROM 16 that holds control programs for the CPU 15, initial setting data and the like, an RAM 17 that temporarily stores data input to and output from the CPU 15, a nonvolatile bulk memory module 18 such as a hard disk or a memory card that stores movie or music contents, an external input and output interface 19 that is used to connect an external computer or an external display, a television receiving module 20 that receives a television broadcast, a power supply circuit 21 that selectively supplies a normal operation voltage and a standby operation voltage to the above-explained components 11 to 20, and a battery 22 that is charged and discharged under the control of the power supply circuit 21. The power supply circuit 21 is connectable to an AC adapter 23 that converts an alternating voltage from an active commercial power source into a direct-current voltage suitable for the power supply circuit 21, and the battery 22 is charged when connected to the AC adapter 23. The CPU 15, the ROM 16, the RAM 17, the bulk memory module 18, the input and output interface 19, the television receiving module 20, the key-operation module 12, and the remote controller light receiving module 13 serve as a processing circuit that processes video information to be displayed in the display module 11 and audio information to be output from the speaker module 14. In this processing circuit, the CPU 15, the ROM 16, and the RAM 17 serve as a control module that controls the output module, i.e., the display module 11 and the speaker module 14 based on an output signal from each of the key-operation module 12 and the remote controller light receiving module 13.

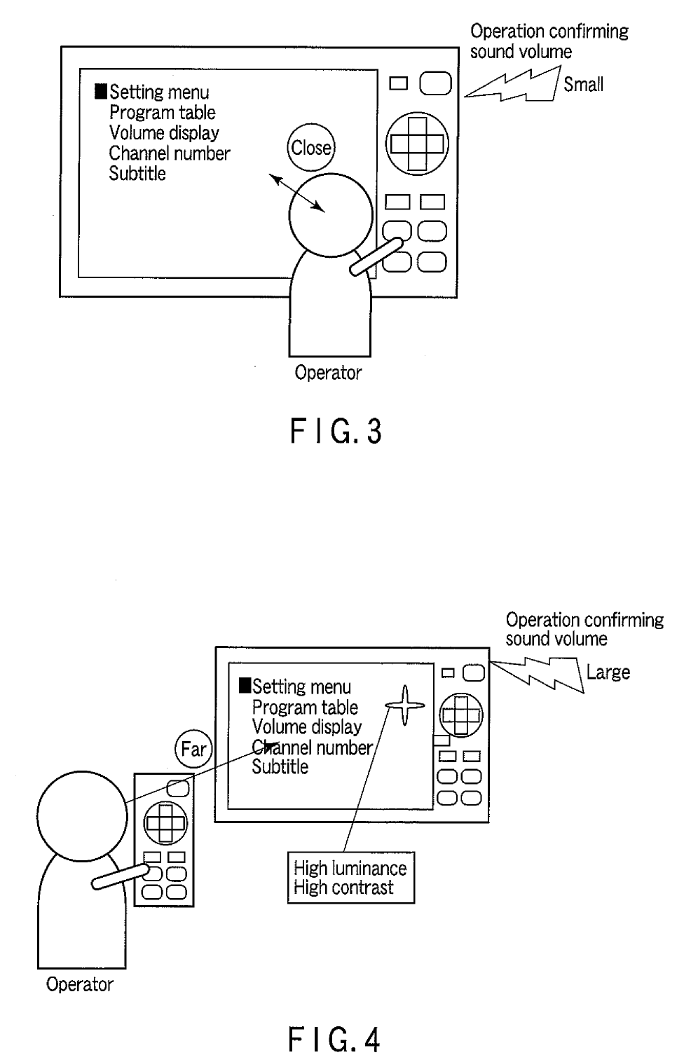

FIG. 3 shows an output state obtained when a menu command is input by an operation of the key-operation module 12 on a main body of the portable audio player GB. In this case, a display of the menu window and an output of the operation confirming sound are made for an operator who is close to the portable audio player GB. The menu window is displayed on the display module 11 with a character size (a display size)=“small”, luminance=“low”, and contrast=“low”, and the operation confirming sound is output from the speaker module 14 with a sound volume=“small”.

FIG. 4 shows an output state obtained when a menu command is input by an operation of the key-operation module 12KM on the remote controller RM. In this case,

a display of the menu window and an output of the operation confirming sound are made for an operator who is not close to the portable audio player GB. The menu window is displayed on the display module 11 with the character size (the display size)=“large”, the luminance=“high”, and the contrast=“high”, and the operation confirming sound is output from the speaker module 14 with the sound volume=“large”.

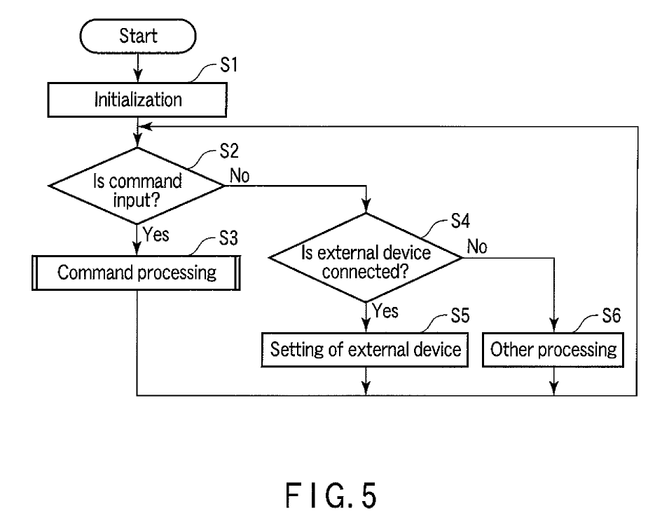

FIG. 5 shows a control operation of the CPU 15. The CPU 15 operates to execute a control program under the normal or standby operation voltage fed from the power supply circuit 21. When this operation is started, the CPU 15 initializes the components 11 to 20 based on initial setting data at block S1. At block S2, it is checked whether a command is input from one of the key-operation module 12 and the key-operation module 12RM. When input of a command is confirmed, command processing is performed at block S3, and then block S2 is executed again. When input of a command is not confirmed, it is checked at block S4 whether an external device such as an external display or a computer has been connected. When connection of an external device is confirmed, setting of the external device is carried out at block S5. For example, when the external display is connected, a specification of this external display is acquired in this setting of the external device, and standard luminance, contrast, a character size (a display size), a sound volume, and others are set within ranges that satisfy the specification. When the computer is connected, a setting for enabling an access of the bulk memory module 18 by the computer is carried out in this setting of the external device, and then block S2 is executed again. Furthermore, when connection of the external device is not confirmed at block S4, other processing is executed at block S6, and then block S2 is executed again.

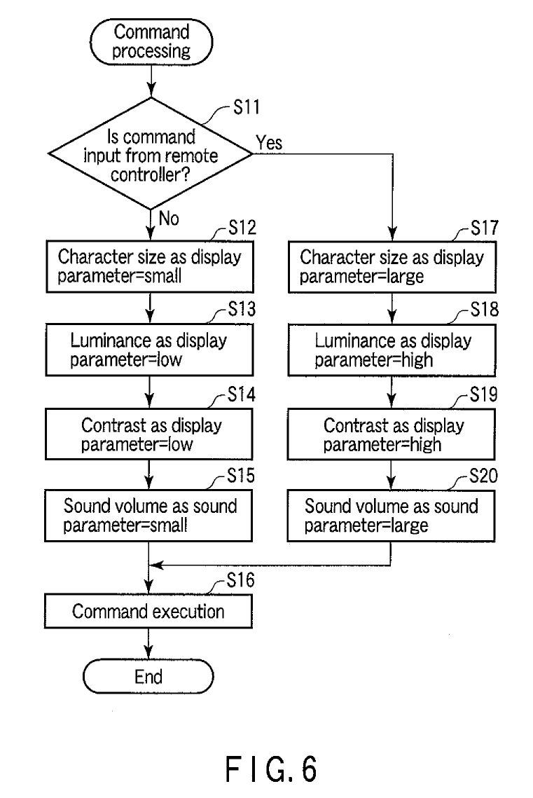

FIG. 6 shows command processing shown in FIG. 5 in detail. When this command processing is started, it is checked at block S2 whether the command input confirmed at block S2 is performed by the remote controller RM. When the key-operation module 12 is detected to be operated for the command input, it is determined at block S11 that the command is not input from the remote controller RM, and blocks S12 to S15 are executed. That is, a character size (a display size) as a display parameter is set to “small” at block S12, luminance as a display parameter is set to “low” at block S13, contrast as a display parameter is set to “low” at block S14, and a sound volume as a sound parameter is set to “small” at block S15. After execution of block S15, the command is executed at block S16 In this case, display output of the display module 11 and sound output of the speaker module 14 are made in a manner shown in FIG. 3 through the settings at blocks S12 to S15. The command processing is terminated after execution of block S16.

On the other hand, when it is confirmed that the command input is detected by the remote controller light receiving module 13, it is determined at block S11 that the command is input from the remote controller RM, and blocks S17 to S20 are executed. That is, a character size (a display size) as a display parameter is set to “large” at block S17, luminance as a display parameter is set to “high” at block S18, contrast as a display parameter is set to “high” at block S19, and a sound volume as a sound parameter is set to “large” at block S20. After execution of block S20, the command is executed at block S16. In this case, display output of the display module 11 and sound output of the speaker module 14 are made in a manner shown in FIG. 4 through the settings at blocks S17 to S20. The command processing is terminated after execution of block S16.

As a specific example, when the menu command is input by an operation of the menu key 12D, a menu window obtained by executing the menu command is displayed on the display module 11 as shown in FIG. 3 or FIG. 4.

311 In the menu window, a cursor also displayed so as to designate one of menu items provided as selection candidates. When the cursor is moved down to designate the next menu item “program table” by operating one of the cursor movement keys 12B and this menu item “program table” is selected by operating the decision key 12C, a program table command is input. In this case, a program table window obtained by executing the program table command is displayed on the display module. Moreover, when the cursor is further moved down to designate the menu item “subtitle” by operating one of the cursor movement keys 12B and this menu item “subtitle” is selected by operating the decision key 12C, a subtitle command is input. In this case, a subtitle window obtained by executing the subtitle command is displayed on the display module. It is to be noted that the operation confirming sound for each command input is output as shown in FIG. 3 or FIG. 4.

In this embodiment, which one of the key-operation module 12 and the remote controller RM is used to input a command is checked and the output state of the output module (the display module 11 and the speaker module 14) is changed for an operator who is at a position apart from the output module when it is confirmed that the command is input from the remote controller RM. Here, the fact that the remote controller RM has been used by the operator serves as a criterion for determination that the operator is at the position apart from the output module. In the case where the output state such as a character size or a sound volume is changed for the operator who is at the position apart from the output module based on this determination, easiness of viewing and listening by the operator can be improved. Even if the operator is at a position near the output module, this operator is able to input another command by using the key-operation module 12 on the device main body. Thus, an inconvenience due to a change in the output state does not occur.

The present invention is not limited to the aforementioned embodiment and various modifications can be made without departing from the scope of the invention.

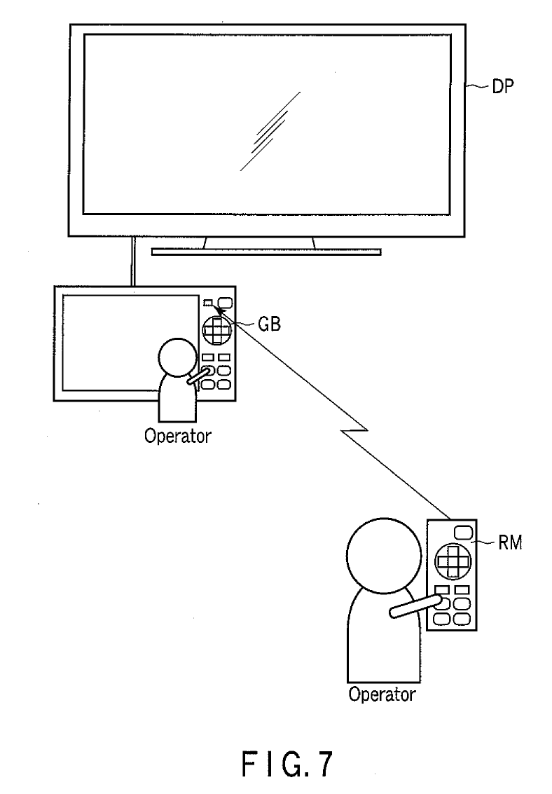

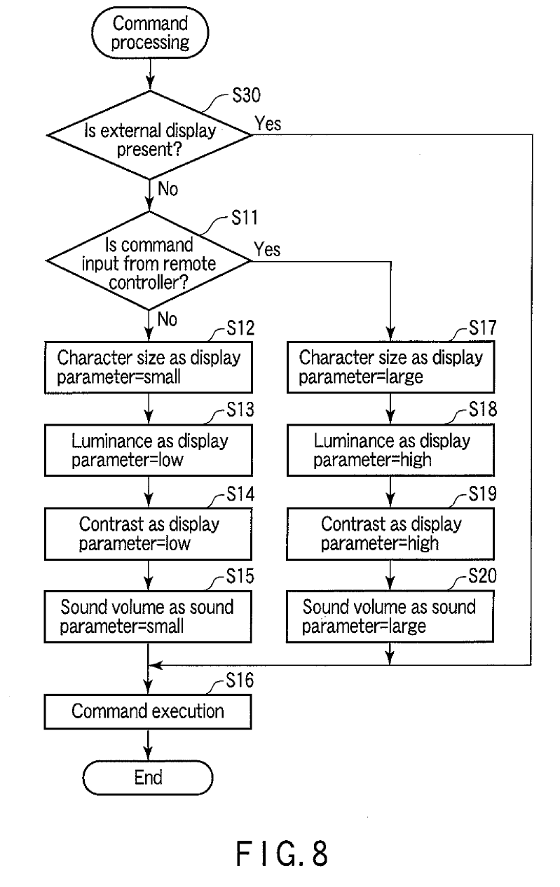

FIG. 7 shows an example where a large external display DP is connected to the portable audio player GB with the use of the external input and output interface 19. The portable audio player GB can be configured such that all the display characters and operation confirming sound are always output from the external display DP connected to the portable audio player GB as described above. The setting of the external device performed at block S5 in FIG. 5 is a standard one which does not obstruct viewing and listening of the display characters and operation confirming sound by an operator who is at a distanced position. Therefore, when the external display DP is usable to output the display characters and operation confirming sound, the command processing shown in FIG. 6 may be modified as shown in FIG. 8, for example. That is, in the command processing of this modification, it is checked at block S30 prior to block S11 whether an external display DP is present, and block S16 is executed when presence of the external display DP is confirmed. That is, a change in the setting of the output state such as a size of display characters, a sound volume of operation confirming sound, or the like of the output module (the display module 11 and the speaker module 14) is omitted. When the external display DP is utilized to output the display characters and operation confirming sound, an operator who is at a distanced position can readily view and hear them even if such omission is carried out.

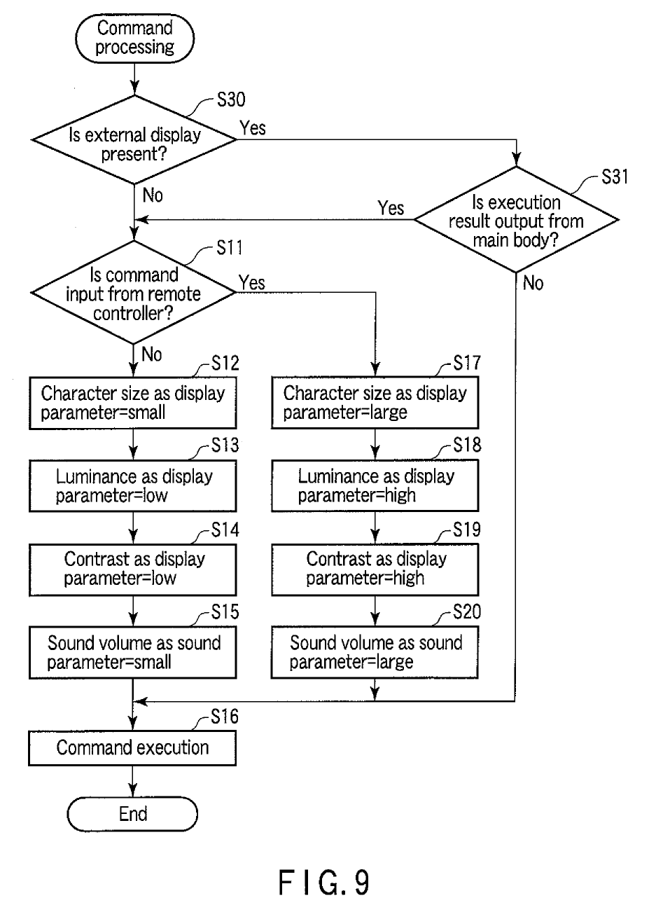

351 Further, the portable audio player GB can be configured such that one of the portable audio player GB and the external display DP is selected, and display characters and operation confirming sound are output from the selected one. In this case, one of the portable audio player GB and the external display DP is selected in advance in the setting of the external device carried out at block S5 in FIG. 5, and this setting is arbitrarily changed using a setting menu in the menu window. To cope with this change, the command processing shown in FIG. 6 is modified as shown in FIG. 9, for example. That is, in the command processing of this modification, it is checked at block S30 prior to block S11 whether an external display DP is present, and it is checked at block 31 whether a command execution result, i.e., the display characters and the operation confirming sound is output from the portable audio player GB main body when presence of the external display DP is confirmed. When it is confirmed that the command execution result is output from the portable audio player GB main body, block S11 is executed. On the other hand, when it is confirmed that the command execution result is output from the external display DP, a change in the setting of the output state such as a character size of the display character, a sound volume of the operation confirming sound or the like of the external display DP is omitted and block S16 is executed.

With the configuration described above, the display characters and the operation confirming sound can be output by using a selected one of the portable audio player GB and the external display DP. Further, when the external display DP is utilized to output the display characters and operation confirming sound, an operator who is at a distanced position can readily view and hear them even if the omission described above is carried out.

It is to be noted that both the display characters and the operation confirming sound are output as a command execution result in the foregoing embodiment, but the setting menu can be utilized to perform a setting for selecting an output of the display characters or an output of the operation confirming sound. Moreover, some of items, i.e., a character size, luminance, contrast, a sound volume, and any other output state which should be changed for an operator who is at a position apart from the portable audio player GB may be selectively set by utilizing the setting menu, for example.

Additionally, although the portable audio player GB has many commands which are input by a combination of key operations, e.g., operating the cursor movement key 12B to move the cursor to a position where a desired menu item is designated and operating the decision key 21C to select this menu item in the menu window, processing of an above-explained command is kept unexecuted until input of the command has been completed. Thus, checking is effected for each key operation to confirm which one of the key-operation module 12 and the remote controller PM is used, and the output state of the output module is changed for an operator who is at a position apart from the output module when the remote controller RM is used for the key operation. If it is necessary to reduce the load on the CPU 15 in checking for each key operation, the key operation may be limited to a specific key like the cursor movement key 12B, and the confirmation of each input command may be performed in parallel with the confirmation of one of the key-operation module 12 and the remote controller RM which is used for the operation of the specific key. Here, selection of a menu item displayed in the menu window is processed as input of a command. When a sub-menu window is displayed upon selection of this menu item, selection of this sub-menu item is also processed as input of an independent command.

Further, the present invention is applicable to not only the portable audio player GB, but also an information processing device such as a portable DVD player including a video display.

It is to be noted that the display module 11 shown in FIG. 1 is the video display formed of, e.g., a liquid crystal panel or an organic EL panel, it may be a touch panel type video display obtained by integrating a transparent tablet with a liquid crystal panel or an organic EL panel. Further, in this case, the tablet may be utilized to detect a key operation of a key displayed on the liquid crystal panel or the organic EL panel to assist input of a command.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
an output module configured to output video and audio information; and
a processing circuit configured to process the video and audio information to be output from the output module;
wherein the processing circuit comprises a key-operation module configured to receive a command, a detecting module configured to detect a command input from a remote controller, and a controller configured to control the output module based on a command received from the key-operation module or the detecting module, and
the controller is configured to confirm which one of the key-operation module and the remote controller is used to input the command and to switch an output configuration of the output module for an operator remote from the output module when the command is received from the remote controller.

2. The device of claim 1, wherein the controller is configured to change a character size when the output configuration of the output module is switched.

3. The device of claim 1, wherein the controller is configured to change a sound volume when the output configuration of the output module is switched.

4. The device of claim 1, wherein the controller is configured to change luminance when the output configuration of the output module is switched.

5. The device of claim 1, wherein the controller is configured to change contrast when the output configuration of the output module is changed.

6. A control method for an information processing device comprising an output module configured to output video and audio information and a processing circuit comprising a key-operation module configured to receive a command, and a detecting module configured to detect a command input from a remote controller, the method comprising:
confirming which one of the key-operation module and the remote controller is used to input a command; and
switching an output configuration of the output module for an operator remote from the output module when the command is received from the remote controller.

7. The method of claim 6, wherein a character size is changed when the output configuration of the output module is switched.

8. The method of claim 6, wherein a sound volume is changed when the output configuration of the output module is switched.

9. The method of claim 6, wherein luminance is changed when the output configuration of the output module is switched.

10. The method of claim 6, wherein contrast is changed when the output configuration of the output module is switched.
